(19) United States
(12) Patent Application Publication
(10) Pub. No.: US 2011/0119479 A1
(43) Pub. Date: May 19, 2011

(54) EOOBE-Application to collect information for new computer and manufacturing process

(76) Inventors: Robert Cowie, Escondido, CA (US); Gary Robert Lyons, San Diego, CA (US)

(21) Appl. No.: 12/590,958

(22) Filed: Nov. 17, 2009

(51) Int. Cl. G06F 1/24

(52) U.S. Cl. 713/100

(57) ABSTRACT

A system and method for enhancing the Electronic Out Of Box Experience (eOOBE) for individuals who are ordering a new or replacement device from the device manufacturer. The user is able to select an option to complete the eOOBE setup prior to receiving the new device, where the new device may be a computer, phone, PDA, or other electronic device. An application such as an applet is downloaded from the manufacturer and the application collects device settings and user preferences, as well as file system information, storing the information to a file on the local device file system. This gathered information may include acquiescence to Electronic User License Agreements (EULA), such that these licenses may be pre-configured with the user's agreement before the device is shipped to the user. The collected information is encrypted and sent to the manufacturer, where the manufacturer then builds and configures the new device in accordance with the received data file. The new device is delivered to the user and the user is able to operate the new device in fully configured and activated mode directly out of the manufacturers shipping container. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Ordering a new electronic device such as a computer, phone, or other electronic device online is only the first step in successfully configuring and using such a new device. Although data migration and transfer systems assist a user in easily moving data and sometimes device settings from the old device to the new device, these migration activities usually occur only after the new device has been received and require time and attention on the part of the user.

Oftentimes the user is the one person least qualified to migrate data or manipulate device settings to achieve the desired level of functionality and personalization. Manufacturers have attempted to make this process easier by offering technical support for the migration and setup of new devices, but, once again, these processes usually only occur after the device has been built in a factory setting mode and shipped to the user. The user is also required to be involved in the setup and personalization of new devices, as there is often no way that a manufacturer is able to capture and maintain the settings and preferences data that is required to configure a new device without having the user actively involved at the factory.

In addition, the type of information required for such personalization is often very sensitive to each user. Data security is of utmost importance to each user. Every user wants to make sure, in this day and age of identity theft, that the personalized settings data is shared with as few outside parties as possible, and that when transmitted the data is secure against intrusion and theft.

Receiving a new device from a manufacturer that provides all of the migration and personalization expectations of a user would be a marketing boon to any device manufacturer. Not only will each user who is the recipient of such a device be extremely happy from a customer service point of view, but the device manufacturer may also save time and money on the technical staff necessary to assist users in the configuration and personalization of new devices sent from the factory.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a diagram of an exemplary electronic out of box experience system for a plurality of devices consistent with certain embodiments of the present invention.

FIG. 2 is an illustrative process flow diagram of the out of box update system as a whole consistent with certain embodiments of the present invention.

FIG. 3 is an illustrative process flow diagram of the user interaction when ordering a new device using the electronic out of box system consistent with certain embodiments of the present invention.

FIG. 4 is an illustrative process flow diagram of gathering data for multiple devices consistent with certain embodiments of the present invention.

FIG. 5 is an illustrative process flow diagram reverting the eOOBE process consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Software and/or firmware embodiments may be implemented using one or mores programmed processors executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

Content may be embodied as any or all audio, video, multimedia or interactive data that may be encoded with entertainment, training, artistic, textual, or experimental subject matter that is created for playback in modes such as compact disc (CD), digital versatile disc (DVD), high definition DVD (HD-DVD), Blu-ray Disc (BD) of any suitable format, tape, Internet streams or downloads, handheld players, computer storage media or any other suitable playable modes.

When processing an order for a new device from a manufacturer, customers are understandably anxious to make sure that the new device functions at least as well as the device they are replacing. The functional expectations include the migration of existing data and personalized settings within the device, as well as network settings, passwords and other entry codes for software applications installed on the device, the installation of the software applications themselves, operating system settings, and security settings for the user, and other personalized parameters that provide the accustomed operational environment the customer has aggregated over time and use of the device. The migration of data and security settings is simply one step in recreating an entire operational environment. Although the manufacturer may provide factory standard settings for the operating system, networking parameters, and any software suite ordered by a customer, the personalization of the device, which may include not only optimized software application settings, but also the wallpaper and look and feel of the user interface, is left up to the customer when the device is received at the customer location.

The instant disclosure allows a customer ordering a new device from a manufacturer to make choices and capture relevant data from an existing device and apply these captured settings and preferences as the device is configured at the factory. In this manner, the customer will receive a device that operates exactly as the customer desires, up to and including personalized wallpaper and software application settings for example, right out of the box. Thus, when the customer receives their device it will capture all of the time and effort the customer has input in aggregating desired settings and use parameters in the device being replaced, and the device will be operational within a very short time of unpacking at the customer location.

To accomplish this goal, the customer contacts the device manufacturer and initiates and order for a new device. Upon the receipt of an order indication, the manufacturer causes an applet (or other suitable application) to be downloaded from the origination server into the device in communication with the origination server. The origination server may be located at a factory, manufacturer's location, sales office, or anywhere an order is placed for fulfillment. This applet is a tool that not only identifies settings and files from the existing device, but also has information regarding all of the setup components from the existing device that a user would need to have built into the new device. The information transmitted by the applet to the factory allows the factory to complete the traditional build and setup that a new device and operating system requires, while merging existing user settings during the manufacturing process such that the user settings and preferences are a native portion of the new device, prior to shipment. In a non-limiting example, if a user had a Wireless Wide Area Network (WWAN) account on the existing machine that the new machine is intended to replace, that account could be transferred to the new machine by the user inputting the required account logon information and the WWAN would automatically be activated in the new device against the existing account the moment that the user turned on the new device.

Additionally, the application could be active to store the combined settings (retrieved by the applet) and user choices (made by the user during the interaction with the applet) to a local storage device. This local storage device may be a Hard Disk Drive (HDD) recovery partition, recovery disc, or other local storage media, online server, or any other locally accessible data storage device such that if the system crashes the applet collected data is securely stored. This may allow the recovery of the data from the storage device such that during the recovery process the user does not need to interact with the recovery process to duplicate the same results achieved during the original electronic Out Of Box Experience (eOOBE).

The eOOBE is available for a number of devices that may be ordered electronically. Informational devices such as smart phones, gaming devices, computers, and personal digital assistants, may all be ordered via a web-based or other electronic connection to a manufacturer of such devices, although this list is by no means an exhaustive list of the devices that may be so ordered and is not intended to limit the process to the devices named in this list. When the device is ordered from the factory in addition to the personal components and machine settings, the application may also send to the factory a list of software applications that may require upgrading to the most recent version. In this fashion, the device that is delivered to the user may contain the most recent versions available at the factory for all of the software applications that a user requires on the device. For corporate users, the application may merge individual, personal settings and choices with those required by an IT group responsible for enforcing corporate standards. Such a merge would provide the user with a new device that would conform to corporate standards set by responsible groups within the corporation, resolve conflicts between personal settings and corporate mandates, and provide the user with a device that is fully functional in accordance with corporate guidelines yet incorporates the user's personal choices and settings where possible. The application will also collect from the user information regarding the upgrade from an existing device to a device that is more capable of complex operation based upon technical specifications, provides better access or control, or is more advanced in terms of the design, look and feel of the device. In this fashion, the user may specify an upgrade over the existing device from which the order is being placed.

To enhance the user experience with a new or replacement device ordered electronically, there is a need for an application that may be operative to collect user preferences and settings, corporate settings, and send these to a factory such that the ordered device may delivered from the factory in hibernate mode and ready to be placed in operation with all user rights, privileges, settings, and choices in place and operational right out of the box, thus providing the user with a true eOOBE.

The eOOBE process is not simply about data and settings migration from one previously owned device into a second device that is being newly built. The system is about enhancing the customer experience for the user by building a device that has all settings and preferences built into the device systems during the manufacturing process. Only in this manner may a user contract for and receive a device that is literally custom built for that user, which not only maximizes the customer satisfaction experience but also customizes the device at very basic levels that cannot be matched by a device that is built to a standard template and then has customer settings and preferences applied later in the process. In such a device, preferences and settings that may not be applied to a standard unit because those settings are burned into device logic or built as a portion of the binary code of the operating system kernel that may not be changed later. In such an exemplary embodiment, the user ordered device will have the user preferences and settings available to the factory systems such that these user preferences and settings are integrated into the basic templates for the hardware and software systems of the device and may be set to the user preferences at a customization level instead of applied later at a standard setup level for the device.

In another exemplary embodiment of this customization process, the factory where the device is built may have an intelligence engine that is used for inferring settings for particular subsystems of the device from given preferences and settings input by a user. In a non-limiting example, in a computer device a user may specify a high contrast theme as being enabled for the display settings in an ordered computer device. At the same time, the user may have the magnifier setting turned on in the display “Ease of Access Center.” Given these two conditions, the factory intelligence engine may infer that the user has difficulty seeing the screen, or prefers high contrast, high definition screen settings. As such, the intelligence engine may then pre-configure other parts of the computer device systems, such as the Narrator, which the user may not be aware of, that will enhance the users experience with the screen display and the use of the computer device.

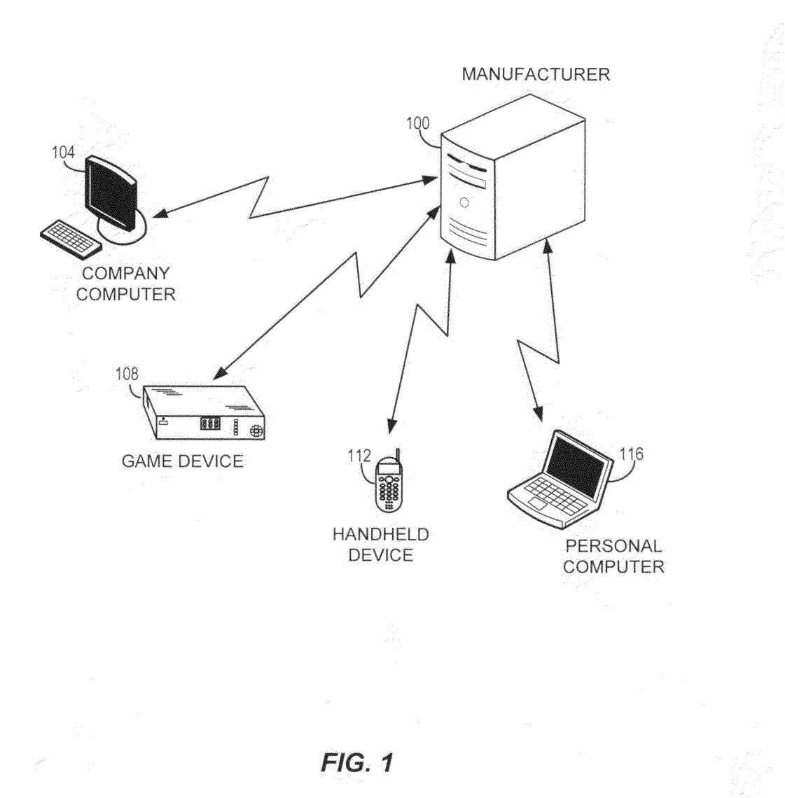

Turning now to FIG. 1, consistent with certain embodiments of the invention this figure presents an exemplary view of one possible system configuration. In this exemplary configuration, a manufacturer may operate a system server 100 that is connected to the world outside of the factory through a network communication channel. This channel may consist of a connection to the Internet, may be connected directly to a network such as through an ftp connection, or may be a part of an intranet that connects outside the factory through a firewall server. The factory may be in the business of supplying computers 104, game devices 108, handheld devices 112, or laptop or other personal computers 116, or any other electronic device that contains a processor capable of communicating with the factory. In this configuration, the factory server 100 will accept incoming orders for new devices from users through an online ordering system. The system will then download a software application (such as an applet) to the user's device, collect personal settings and choices as well as corporate and machine settings, and process the order to build a new device that incorporates all of the settings and choices required by the user. The factory will then send the new device, possibly in hibernate mode, to the user and the user will be able to open the box and extract a fully functioning device for a true eOOBE that will meet customer expectations and enhance the factory's reputation for customer service in the marketplace.

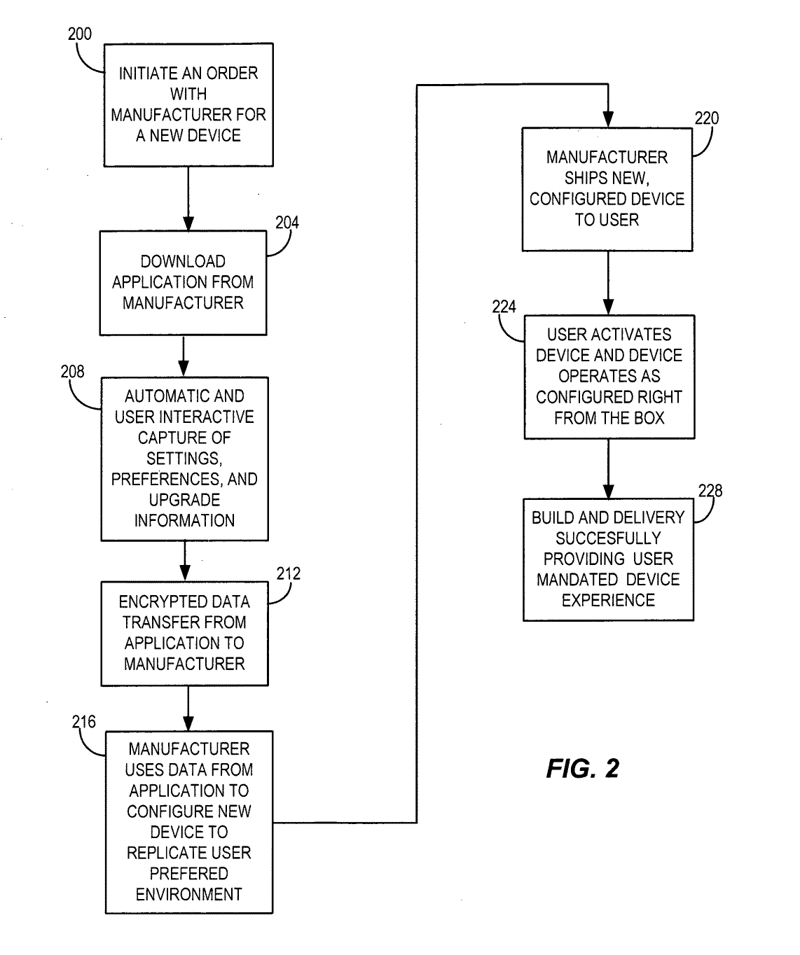

Turning now to FIG. 2, consistent with certain embodiments of the invention this figure presents a process flow diagram of the eOOBE update system. In certain embodiments of the eOOBE system the system is initialized by a user who contacts a manufacturer through a network communication pathway to initiate an order for a new device at 200. The new device may be a replacement unit or an additional unit for the user, but in each case in this exemplary embodiment the user desires the new unit to be personalized to perform in the same manner and method as a unit currently in the user's possession, and to have the new unit operate as desired the moment it is taken from the factory shipping container. To accomplish this goal, the user first downloads an application at 204, which may, in a non-limiting example consist of an applet, from the factory server to the device that is in contact with the origination server across the network communication channel. The software application downloaded at 204 may also consist of other exemplary compiled or interpreted software code that may be initiated and perform the eOOBE data collection process. Upon download and activation, the application begins the eOOBE process by automatically capturing main processor settings, network settings, power settings, user logon information, operating system settings (if applicable), and communication channel settings at 208. In addition to these settings, the application also initiates a series of user interaction screens that will interrogate the user and gather user preferences for look and feel, Graphical User Interface (GUI) setting preferences, user security logon information and other logon information, preferred software applications, and personalized software configuration information 208. In a preferred embodiment, this gathered information may include acquiescence to Electronic User License Agreements (EULA), such that these licenses may be pre-configured with the user's agreement before the device is shipped to the user. This interaction with the user is captured by the application and appended to the automatically captured device settings, all of which is saved by the application to local device storage awaiting later transmission to the manufacturer. The application will also interrogate the user as to upgrade preferences for any software applications the user has identified in the gathering of software suite configuration information. In an exemplary embodiment, if the user requests the installation of a software application for which the manufacturer has a more current release or version, the user may request that the installation of that particular software application be the more current release or version than the version currently installed on the operative device. Advantageously, by submitting a user preference for the more current release of a software application, any boot or setup screens will have already been configured according to user preferences prior to receipt of the device. As a non-limiting example, if the user indicates a preference for an upgrades Microsoft™ application software package, the device will be so configured at the factory such that the standard Microsoft first boot configuration screens are processed prior to shipping the device with the result that the user never sees these screens as these screens are skipped over from the user's perspective. The user may also, in the alternative, request that the manufacturer install only those versions of software that currently reside on the existing device as the user may prefer the familiar software version be installed in the new device. For those situations where only the new version or release of a software application may be installed on a new device due to contractual obligations of the device manufacturer with the software manufacturer, the user will be informed of that situation. The user may also select upgraded performance or design, look and feel and store these preferences with the collected data accumulated by the application. The upgrade information is then appended to the data file in local storage that is to be sent to the manufacturer.

In an exemplary embodiment, once all settings, preference, and upgrade data have been captured by the application through the automatic and user interrogation data gathering processes, the application completes the append of information to the locally stored data file and associates the data file with an identifier. In a non-limiting example, the identifier may be a workorder number that is consistent with the tracking system in use by the manufacturer. The application then encrypts the data file and transfers this encrypted file to the manufacturer across the network communication channel at 212.

In an exemplary embodiment, the manufacturer receives the encrypted data file from the application and decrypts the received file. The identifier is pulled from the data file and used to open a tracking file in the manufacturer's factory tracking system. The rest of the data comprising the collected setting, preference, and upgrade data from the user is then downloaded into the manufacturer's system. This data is then used by the manufacturer to configure a new device in accordance with the collected user device setting, preference, and upgrade information at 216. The device is built and tested in the factory to ensure that the device complies with the application collected information. When the device is complete and tested, the manufacturer then ships the new, configured device to the user. In one implementation, this is accomplished by placing the device in hibernate mode and shipping it to the user at 220.

In this exemplary embodiment, the user receives the device as shipped from the manufacturer. The user may pull the new device from the shipping container and activate the device, whereupon the new device operates as configured and in accordance with the user's preferred settings and choices right from the box at 224. This operation straight from the box provides the level of operation and choice mandated by the user at 228 and provides for a satisfactory eOOBE straight from the manufacturer for each new device ordered in this manner.

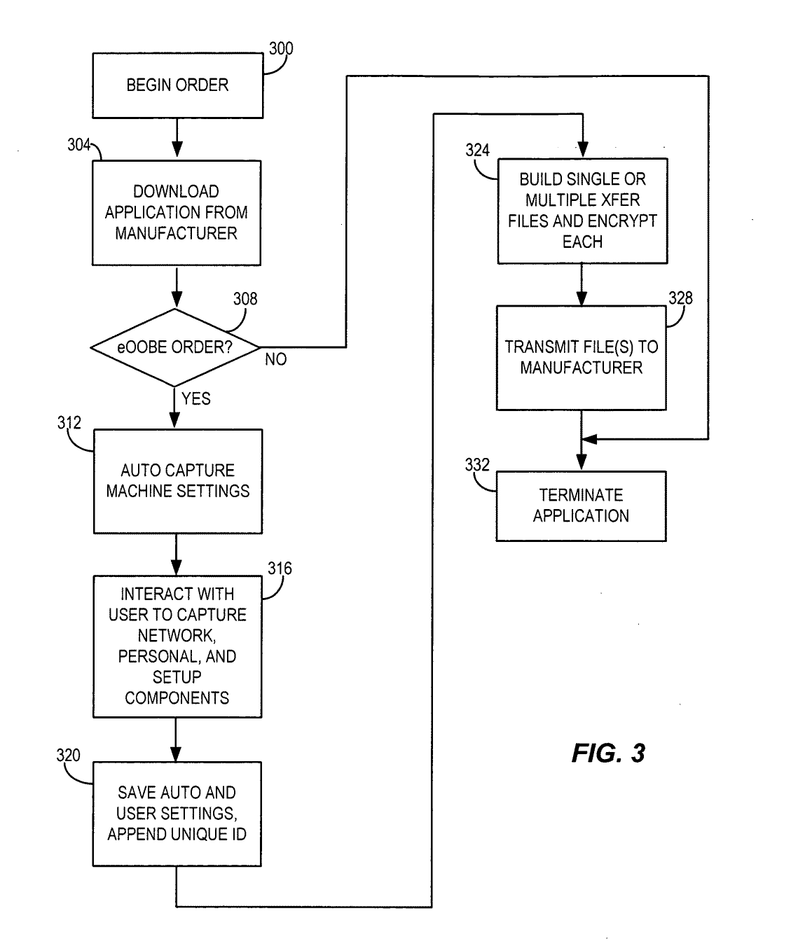

Turning to FIG. 3, in certain embodiments of the invention the eOOBE begins at 300 when a user initiates an order from a device manufacturer and the server at the manufacturer factory site downloads an application at 304 (which in an exemplary embodiment may be an applet) that is designed for the device that is in communication with the factory. The application interrogates a user to determine if the user is choosing to order a new device using the eOOBE process at 308. If the user selects the eOOBE process at 308, the application continues operation. If the user does not select the eOOBE process at 308, the application terminates at 332. The application is designed to automatically capture internal machines settings at 312 for the device and save these settings into a local storage file. The application, in an exemplary embodiment, is also configured to present screens to the user to collect user preference information at 316. The screens are designed to present the same look and feel to the user as the primary screens in normal use by the device. In a non-limiting example, if the device being ordered by a user were a computer system with a Microsoft operating system to be installed on the device, the screens presented to the user would have the same look and feel as the standard desktop the Windows operating system would usually present during normal operation. The data to be collected by these screens are data regarding user preferences, such as wallpaper preference, personalized software configuration, acquiescence to EULAs, logon parameters, and other personalized information that will result in the configuration of the new device being the same as the device to be replaced or copied.

In an exemplary embodiment, the application may then save the data gathered through both the automatic collection and the data screen collection in a local data file at 320. In addition, the combined settings and user choice data may be stored in a location on the local disc such as a Hard Disk Drive (HDD) recovery partition, a recovery disc or media, or an online server so that if the system or device crash during the ordering or data gathering process, the data has been saved to recoverable memory. In the exemplary embodiment, during the recovery process the user does not need to interact with the recovery process to duplicate the same results achieved during an original eOOBE action. The application also attaches a unique identifier to the combined collected data that will be recognized at the manufacturer at 320.

In the exemplary embodiment, the application may partition the accumulated collected data into a single file, or into multiple files at 324. The partitioning may be performed to allow the data to be transmitted in the most efficient manner possible, and to provide for greater data security when the collected information exceeds a pre-defined number of data records. The data file, or files, may then be encrypted at 324 prior to transmission to the manufacturer at 328. At the end of the transmit action the applications work is finished and the application terminates at 332.

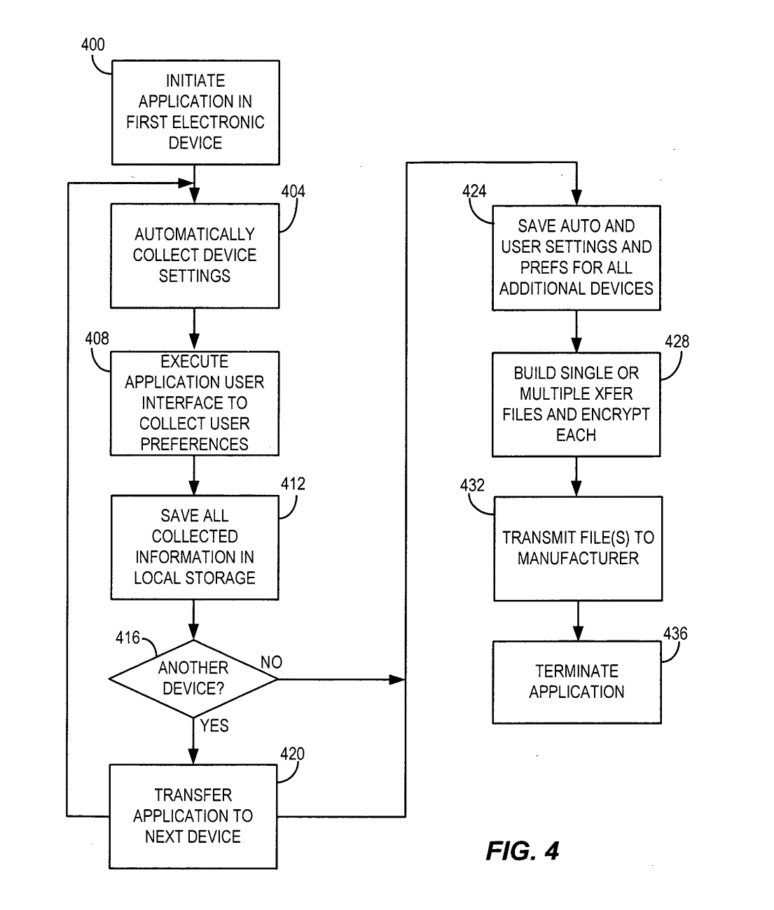

Turning now to FIG. 4, in another exemplary embodiment an application (which may be an applet) may be downloaded from a device manufacturer that is used to collect device setting and user preference information from a plurality of devices that each contribute information toward the configuration of a new device being ordered. As in other embodiments, the user initiates an order activity with a device manufacturer whereupon the device manufacturer downloads an application to the user on the device being used to order the new device. The application is initiated within a first device at 400 and automatically collects device settings, including any operating system settings, if applicable, as well as logon information and configuration settings at 404. The application then presents a number of user screens to the user operating the ordering device to query the user for user preferences and software choices at 408. This step may include the collection of acquiescence responses for any EULAs that may need to be answered when configuring software applications requested on the new device by the user.

In the exemplary embodiment, when the application has concluded the automatic acquisition of device system and configuration settings, and all user requested parameters, the application stores all the information from the first device in a locally stored file at 412. The application also may store the information in an HDD recovery partition to secure the data against premature termination of operation on the ordering device. The application may then request of the user whether there are particular settings for the device being ordered that reside on another device at 416. In a non-limiting example, this may be true if there are corporation level settings that are maintained on additional devices that are maintained by the corporate IT department, or there may be a desire by the user to collect settings and preferences from a second device that is separate from the ordering device 420. In this case, the user may transfer the application to a second device through a network communication channel and the application will perform at 404 through 412 as enumerated above for the second device, integrating the settings and preferences information from the second device with the information gathering from the ordering device. If the user does not require additional settings or preferences to be collected from an additional device, the application collects only those settings and preferences for the single device. The application may then store all settings and preferences information gathered from all devices within a local storage file at 424.

In the exemplary embodiment the application will then segment the gathered information into one or more files in preparation for communicating the information to the manufacturer at 428. The file(s) are encrypted by the application at 424, and then all of the encrypted files, including a unique identifier that will assist the manufacturer in associating the ordered device with the user ordering the device, may be transmitted to the manufacturer at 432 for use in configuring the ordered device. The application then terminates from all devices upon which it has been loaded at 436.

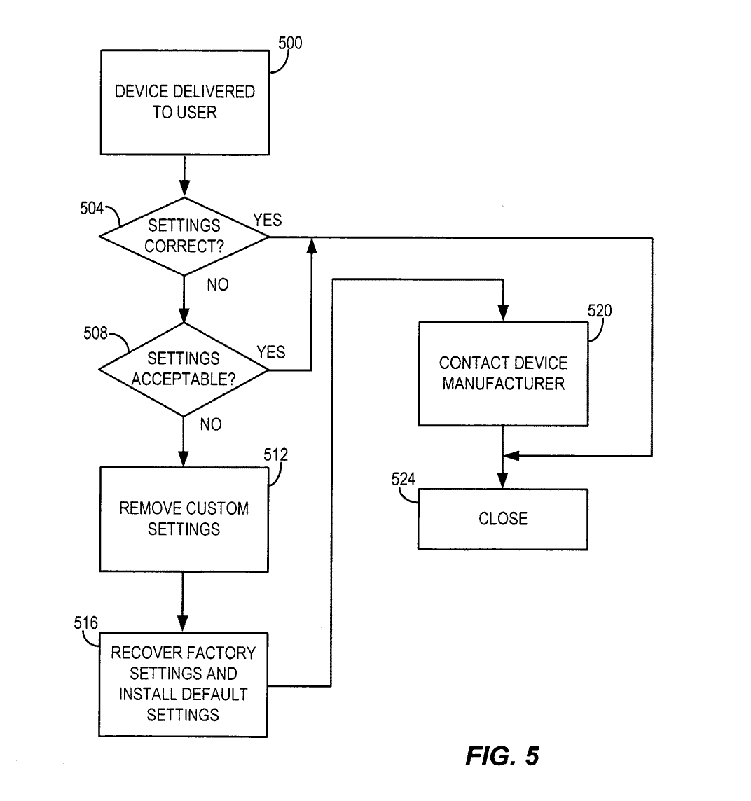

Turning now to FIG. 5, this figure presents an exemplary embodiment for the reversion of the eOOBE process. Upon delivery of the device to the user at 500 the user will remove the device from the shipping container and activate the device. Upon activation, the user will inspect the settings and preferences that have been installed within the device in accordance with the user communication with the factory through the eOOBE application. If the settings are correct at 504, the user will close their interaction with the eOOBE process at 524 and continue to operate the device as delivered. If the settings are incorrect at 504, the user will have the opportunity to determine whether the settings are acceptable at 508, and, if acceptable, will once again close their interaction with the eOOBE process at 524.

If, however, in this exemplary embodiment, the user determines that the settings delivered with the ordered device are neither correct, nor acceptable, the user will have the opportunity to revert from the custom settings installed within the delivered device and install a factory default setup. To accomplish this, in a non-limiting example, the device will first remove the device custom settings at 512. The device may then activate a process for recovery of the factory settings at 516 by one of two methods. In the exemplary first method, the device will have a recovery partition or a file stored on internal memory within the device that will contain a factory default configuration for the device. The user may initiate this process whereupon the factory default configuration for the device will be retrieved from the recovery partition or memory file and installed to establish default settings for the device at 516. In an exemplary second method, the device will not remove the custom settings at 512 as in the first method, but will instead recover the factory default settings and install these settings at 516 and ignore the custom settings delivered with the device.

In the exemplary embodiment, if the user has received a device that has the incorrect settings installed and the user has performed the process to revert the device to the factory default settings, the user may then contact the manufacturer as at 520 to report the issue. The user will then close their experience with the eOOBE process at 524.

In the current method for ordering a pre-configured device, a user connects to a device manufacturer across a network communication channel to initiate an order action. The order action downloads an application from a server maintained by the manufacturer to a local device operated by a user and initiates the application on the local device, where the application is operative to automatically collect device settings and configuration information, user input preferences and choices, and user identified files to be installed on a new device. The application appends a unique identifier to the collected data and storing the collected information into a local storage file; and the local storage file is encrypted and transmitted to the device manufacturer for use in the build and configuration of the pre-configured device being ordered by the user.

The downloaded software application comprises an applet and the device settings automatically collected by the application include at least operating system settings, login settings, power settings, network settings, software configuration and files, file system structure, wallpaper, and screensaver settings. The application may also present query screens on the device to collect user information including at least user logon and passwords, End User License Agreement (EULA) acquiescence, software applications installed, upgrade preferences, and look and feel preferences for the device Graphical User Interface (GUI). The files collected by the application further comprise the basic file system of the device and all data populating the file system to be migrated to the device being ordered.

The unique identifier comprises a manufacturer tracking number generated by the application and appended to the information collected by the application. The local storage file saved by the application is encrypted prior to transmission to the device manufacturer and the local storage file is reconfigured into a plurality of files, based upon the amount of data to be transmitted. Each file to be transmitted is optimized for transmission over a network communication channel and each file is separately encrypted.

There is also a computer-readable storage medium comprising computer-executable instructions for ordering a pre-configured device by connecting to a device manufacturer across a network communication channel to initiate an order action. The order action begins by downloading an application from a server maintained by the manufacturer to a local device operated by a user and initiating the application on the local device. The application automatically collects device settings and configuration information, user input preferences and choices, and user identified files to be installed on a new device. Instructions are included for appending a unique identifier to the collected data and storing the collected information into a local storage file and the local storage file is encrypted and transmitted to the device manufacturer for use in the build and configuration of the pre-configured device being ordered by the user.

The downloaded software application may be an applet and the device settings automatically collected by the applet include at least operating system settings, login settings, power settings, network settings, software configuration and files, file system structure, wallpaper, and screensaver settings. The application presents query screens on the device collect user information including at least user logon and passwords, End User License Agreement (EULA) acquiescence, software applications installed, upgrade preferences, and look and feel preferences for the device Graphical User Interface (GUI). In addition, the files collected by the application further comprise the basic file system of the device and all data populating the file system to be migrated to the device being ordered and the unique identifier comprises a manufacturer tracking number generated by the application and appended to the information collected by the application. The local storage file saved by the application is encrypted prior to transmission to the device manufacturer. The local storage file may be reconfigured into a plurality of files, based upon the amount of data to be transmitted, where each file is optimized for transmission over a network communication channel and each file is separately encrypted.

A system for ordering a pre-configured device having a configuration of user desired settings and parameters operated by a user in which the device is in communication with a device manufacturer and an application comprising instructions for collecting information from the device downloaded from the device manufacturer automatically collects device settings and user preference information from the device. The application stores all collected information in a file in local device storage, encrypts the locally stored file and transmits the file to the device manufacturer for use in the build and configuration of a pre-configured device being ordered by the user.

The downloaded software application may be an applet and the device settings automatically collected by the application include at least operating system settings, login settings, power settings, network settings, software configuration and files, file system structure, wallpaper, and screensaver settings. The application also presents query screens on the device to collect user information including at least user logon and passwords, End User License Agreement (EULA) acquiescence, software applications installed, upgrade preferences, and look and feel preferences for the device Graphical User Interface (GUI).

The application further collects files that comprise the basic file system of the device and all data populating the file system to be migrated to the device being ordered. The application appends a unique identifier to the local storage file and wherein the unique identifier comprises a manufacturer tracking number generated by the application and appended to the information collected by the application. The local storage file saved by the application is encrypted prior to transmission to the device manufacturer and the local storage file is reconfigured into a plurality of files, based upon the amount of data to be transmitted, wherein each file is optimized for transmission over a network communication channel and each file is separately encrypted.

While certain illustrative embodiments have been described, it is evident that many alternatives, modifications, permutations and variations will become apparent to those skilled in the art in light of the foregoing description.

What is claimed is:

1. A method for ordering a pre-configured device, comprising:
connecting to a device manufacturer across a network communication channel to initiate an order action;
downloading an application from a server maintained by the manufacturer to a local device operated by a user;
initiating the application on the local device, wherein the application is operative to automatically collect device settings and configuration information, user input preferences and choices, and user identified files to be installed on a new device;
appending a unique identifier to the collected data and storing the collected information into a local storage file; and
wherein the local storage file is encrypted and transmitted to the device manufacturer for use in the build and configuration of the pre-configured device being ordered by the user.

2. A method as in claim 1,
wherein the downloaded software application comprises an applet; and
wherein the device settings automatically collected by the application include at least operating system settings, login settings, power settings, network settings, software configuration and files, file system structure, wallpaper, and screensaver settings.

3. A method as in claim 1, wherein the application presents query screens on the device collect user information including at least user logon and passwords, End User License Agreement (EULA) acquiescence, software applications installed, upgrade preferences, and look and feel preferences for the device Graphical User Interface (GUI).

4. A method as in claim 1 wherein the files collected by the application further comprise the basic file system of the device and all data populating the file system to be migrated to the device being ordered.

5. A method as in claim 1 wherein the unique identifier comprises a manufacturer tracking number generated by the application and appended to the information collected by the application.

6. A method as in claim 1 wherein the local storage file saved by the application is encrypted prior to transmission to the device manufacturer.

7. A method as in claim 6 wherein the local storage file is reconfigured into a plurality of files, based upon the amount of data to be transmitted, wherein each file is optimized for transmission over a network communication channel and each file is separately encrypted.

8. A computer-readable storage medium comprising computer-executable instructions for ordering a pre-configured device, comprising:
connecting to a device manufacturer across a network communication channel to initiate an order action;
downloading an application from a server maintained by the manufacturer to a local device operated by a user;
initiating the application on the local device, wherein the application is operative to automatically collect device settings and configuration information, user input preferences and choices, and user identified files to be installed on a new device;
appending a unique identifier to the collected data and storing the collected information into a local storage file; and
wherein the local storage file is encrypted and transmitted to the device manufacturer for use in the build and configuration of the pre-configured device being ordered by the user.

9. The computer-readable medium of claim 8,
wherein the downloaded software application comprises an applet; and
wherein the device settings automatically collected by the application include at least operating system settings, login settings, power settings, network settings, software configuration and files, file system structure, wallpaper, and screensaver settings.

10. The computer-readable medium of claim 8, wherein the application presents query screens on the device collect user information including at least user logon and passwords, End User License Agreement (EULA) acquiescence, software applications installed, upgrade preferences, and look and feel preferences for the device Graphical User Interface (GUI).

11. The computer-readable medium of claim 8 wherein the files collected by the application further comprise the basic file system of the device and all data populating the file system to be migrated to the device being ordered.

12. The computer-readable medium of claim 8 wherein the unique identifier comprises a manufacturer tracking number generated by the application and appended to the information collected by the application.

13. The computer-readable medium of claim 8 wherein the local storage file saved by the application is encrypted prior to transmission to the device manufacturer.

14. The computer-readable medium of claim 13 wherein the local storage file is reconfigured into a plurality of files, based upon the amount of data to be transmitted, wherein each file is optimized for transmission over a network communication channel and each file is separately encrypted.

15. A system for ordering a pre-configured device, comprising:
a device comprising a configuration of user desired settings and parameters operated by a user;
the device in communication with a device manufacturer;
an application comprising instructions for collecting information from the device downloaded from the device manufacturer;
the application operative to automatically collect device settings and user preference information from the device;
the application operative to store all collected information in a file in local device storage;
wherein the application encrypts the locally stored file and transmits the file to the device manufacturer for use in the build and configuration of a pre-configured device being ordered by the user.

16. The system of claim 15,
wherein the downloaded software application comprises an applet; and
wherein the device settings automatically collected by the application include at least operating system settings, login settings, power settings, network settings, software configuration and files, file system structure, wallpaper, and screensaver settings.

17. The system of claim 15, wherein the application presents query screens on the device collect user information including at least user logon and passwords, End User License Agreement (EULA) acquiescence, software applications installed, upgrade preferences, and look and feel preferences for the device Graphical User Interface (GUI).

18. The system of claim 15 wherein the application further collects files that comprise the basic file system of the device and all data populating the file system to be migrated to the device being ordered.

19. The system of claim 15 wherein the application appends a unique identifier to the local storage file and wherein the unique identifier comprises a manufacturer tracking number generated by the application and appended to the information collected by the application.

20. The system of claim 15 wherein the local storage file saved by the application is encrypted prior to transmission to the device manufacturer.

21. The system of claim 20 wherein the local storage file is reconfigured into a plurality of files, based upon the amount of data to be transmitted, wherein each file is optimized for transmission over a network communication channel and each file is separately encrypted.
